(19) United States
(12) Patent Application Publication
(10) Pub. No.: US 2026/0088317 A1
(43) Pub. Date: Mar. 26, 2026

(54) VANADIUM-CHROMIUM ELECTROLYTE, METHOD FOR PREPARING THE SAME, AND REDOX FLOW BATTERY COMPOSED THEREOF

(71) Applicant: DALIAN RONGKE POWER GROUP CO., LTD, Dalian, Liaoning (CN)

(72) Inventors: Mingming SONG, Dalian, Liaoning (CN); Delu WANG, Dalian, Liaoning (CN); Fanwu ZENG, Dalian, Liaoning (CN); Xinliang GAO, Dalian, Liaoning (CN); Yanbo CHEN, Dalian, Liaoning (CN); Yue HAO, Dalian, Liaoning (CN)

(21) Appl. No.: 19/111,035

(22) PCT Filed: Oct. 27, 2023
(86) PCT No.: PCT/CN2023/127036

§ 371 Date: Mar. 12, 2025

(30) Foreign Application Priority Data
Sep. 15, 2022 (CN) 202211120529.8

(51) Int. Cl. H01M 8/04186; H01M 8/18

(52) U.S. Cl. CPC H01M 8/04186; H01M 8/188

(57) ABSTRACT

A vanadium-chromium electrolyte, a method for preparing the same, and a redox flow battery composed thereof are provided. The vanadium-chromium electrolyte includes active substances and a free acid, the free acid acts as a proton conductive agent after ionization, and the active substances contain at least vanadium ions and chromium ions. The present disclosure further provides the method for preparing the vanadium-chromium electrolyte, which includes the following steps: dissolving a vanadium compound with a free acid, and obtaining a mixed solution of the free acid and vanadium ions through filtering; electrolytically reducing vanadium to an average valence state of 3.5 to 4 valence; adding a chromium compound, dissolving through stirring, and implementing a filtering; and adding pure water and an auxiliary reagent to adjust concentration, and preparing the vanadium-chromium electrolyte.

This application claims priority to and the benefit of Chinese Patent Application No. CN202211120529.8, filed on Sep. 15, 2022, and titled “a vanadium-chromium electrolyte, a method for preparing the same, and a redox flow battery composed thereof”, the disclosure of which is incorporated herein by reference in its entirety.

### TECHNICAL FIELD

The present disclosure relates to the field of redox flow battery, in particular to, a vanadium-chromium electrolyte, a method for preparing the same, and a redox flow battery composed thereof.

### BACKGROUND

As an alloy additive, vanadium can improve the strength and toughness of steel, and plays an important role in the field of alloy steel. Although the amount of vanadium resources is large, the yield of vanadium extracted from vanadium-titanium magnetite depends on the yield of steelmaking, and the content of vanadium slag after enrichment is low, resulting in high refining cost of vanadium. At present, the main use of vanadium is as an additive in steelmaking, and its price is greatly affected by the iron and steel market.

A redox flow battery is a type of battery using liquid to load active substances. It relies on a pump to pump an active liquid into an electrode, where an oxidation-reduction can occur to realize the storage and release of electric energy. Due to the use of water as the solvent, the safety performance of the redox flow battery is significantly better than the safety performance of a lithium ion battery and a sodium ion battery using organic substances as solvents. In addition, due to the excellent cycling performance and recoverability of the redox flow battery, its lifespan cost is significantly lower than the lifespan cost of the lithium ion battery and the sodium ion battery. Therefore, the redox flow battery has broad prospects in the field of energy storage.

A vanadium redox flow battery is the most prominent type of the redox flow battery. It has the advantages of the same element composition on both sides of the positive and negative electrodes, the separation of the power unit and the energy unit, and the easy recovery of liquid vanadium. In recent years, the vanadium redox flow battery has been favored by the energy storage market. However, the initial investment cost of vanadium battery is significantly higher than the initial investment cost of the lithium ion battery due to the high price of vanadium. At the same time, the solubility of vanadium in aqueous solution is limited and the voltage window is narrow, resulting in low energy density of the vanadium battery. The high temperature stability and high energy density of the redox flow battery composed purely of vanadium as active substance cannot be obtained at the same time.

A higher degree of charging may lead to a decrease in the concentration of available active substances in the solution. If continue to charge at a large current, carbon felts at the positive electrode will be corroded under the current, resulting in damage to the battery, and a serious hydrogen evolution reaction will occur at the negative electrode. Therefore, in practice, in order to protect the battery, the charging SOC is usually controlled, which may lead to lower utilization of vanadium.

For an iron-chromium battery, the positive electrode utilizes the potential of divalent and trivalent iron, and the negative electrode utilizes the potential of divalent and trivalent chromium. At the same time, the cost of the iron-chromium redox flow battery is significantly lower than the cost of the vanadium redox flow battery. However, due to the low activity of chromium and the aging phenomenon of trivalent chromium, the loss of activity of chromium after long-term cycle leads to a significant decrease in capacitance, and the reaction temperature needs to be increased. Therefore, it may lead to serious hydrogen evolution reaction while obtaining higher battery efficiency. In addition, as the cycle progresses, iron ions gradually migrate to the anode, resulting in a rapid imbalance of the battery. Since the potential of divalent/trivalent iron is only +0.77 V, once the average valence state of the electrolyte shifts and increases, it is difficult to restore it to the initial state, which is also a fatal disadvantage of the iron-chromium battery. The requirements for battery assembly are extremely harsh at high temperature, thus, it requires the use of high-temperature resistant fluoroplastics. Therefore, although the cost of the electrolyte of the iron-chromium battery is much lower than the cost of the vanadium redox flow battery, the cost of the battery stack is significantly increased.

### Technical Problem

The existing vanadium electrolyte has low utilization rate of vanadium, a narrow range of the voltage window, and low energy density, while the iron-chromium electrolyte cannot operate stably for a long time. Therefore, a vanadium-chromium electrolyte is proposed. The vanadium-chromium electrolyte has the advantages of high utilization rate of vanadium, high energy density, and low watt-hour cost. When applied in the redox flow batteries, it can improve the energy density of the solution and reduce the cost of the battery.

### Technical Solutions

In a first aspect, a vanadium-chromium electrolyte is provided and includes active substances and a free acid, the free acid acts as a proton conductive agent after ionization, and the active substances contain at least vanadium ions and chromium ions.

Furthermore, the active substances are a vanadium compound and a chromium compound.

Furthermore, the vanadium compound is one or more of VO₂, V₂O₃, V₆O₁₃, V₂O₅, CrVO₄, VOSO₄, V₂(SO₄)₃, vanadium dichloride (VCl₂), vanadium oxychloride (VOCl₂), and vanadium trichloride (VCl₃).

Furthermore, the vanadium compound is preferably selected from one or more of vanadium dichloride (VCl₂), vanadium oxychloride (VOCl₂), vanadium trichloride (VCl₃), and VO₂.

Furthermore, the chromium compound is one or more of chromium trichloride, chromium dichloride, chromium sulfate, chromium vanadate, and Cr₂O₃.

Furthermore, the chromium compound is preferably selected from chromium trichloride and/or chromium dichloride.

Furthermore, the vanadium ions have a concentration of 0.1 to 5 mol/L, preferably 0.5 to 3 mol/L.

Furthermore, the chromium ions have a concentration of 0.1 to 2 mol/L, preferably 0.4 to 2 mol/L.

Through research, it has been found that the reactivity of chromium is low, and the aging of chromium will occur with the cycle of the battery, resulting in the loss of activity of the battery. Generally, it is necessary to increase the temperature of the solution, such as above 65° C., to improve the activity of chromium and inhibit the aging of chromium. However, in this way, it will lead to severe hydrogen evolution reactions and energy loss caused by maintaining high temperatures, significantly reducing the energy efficiency of chromium. Generally, the energy efficiency of the DC side of the iron-chromium battery is only about 70%. A certain concentration of vanadium has a good activation effect, especially divalent vanadium, which plays a bridging role in the solution. During the battery process, the divalent vanadium attached to the surface of the electrode catalyzes the activity of divalent and trivalent chromium and inhibits the formation of inert chromium complex ions.

Therefore, furthermore, a ratio of an amount of substance of vanadium to an amount of substance of chromium in the vanadium-chromium electrolyte used for the negative electrode is greater than or equal to 0.3, that is, V:Cr≥0.3. More preferably, the ratio of the amount of substance of vanadium to the amount of substance of chromium is greater than or equal to 0.5.

It should be pointed out that the ion exchange membrane of the redox flow battery cannot completely block the migration of chromium ions and vanadium ions in the vanadium-chromium electrolyte. During the charge-discharge cycle, vanadium ions and chromium ions may migrate between two sides of the ion exchange membrane, resulting in changes in the concentration of the electrolytes on both sides. Here, the concentration range of the electrolyte is only the initial concentration. After the charge-discharge cycle, the vanadium-chromium electrolyte with increased or decreased concentration is a derivative of the vanadium-chromium electrolyte.

During the charge and discharging process of the battery, an amount of substance of vanadium and an amount of substance of chromium participating in the electrochemical reaction in the negative electrolyte are equal to an amount of substance of vanadium participating in the electrochemical reaction in the positive electrolyte, but it does not mean that a total amount of substance of vanadium in the positive electrolyte must be equal to the sum of the total amount of substance of vanadium and the total amount of substance of chromium in the negative electrolyte. Based on the above principle, for the preparation strategy of the positive and negative electrolytes, vanadium and chromium can be set to have the same initial amount of substance and concentration, and a volume ratio of the positive and negative electrodes is calculated and determined according to the amount of substances of vanadium and chromium participating in the reaction. Alternatively, initial volumes can be set to be the same, and corresponding concentrations of the positive and negative electrodes are calculated and determined according to the amount of substances of vanadium and chromium participating in the reaction. The initial volumes and concentrations of the positive and negative electrolytes may be different, but the amount of changes in the number of electrons of active substances participating in the reaction are be the same. In practical application, the initial preparation strategy may be changed according to the change of environment and different application purposes.

Furthermore, a phosphorus compound in the vanadium-chromium electrolyte has a concentration (P) of 0 to 1 mol/L, preferably 0.05 to 0.6 mol/L. The addition of the phosphorus compound can improve the stability of pentavalent vanadium. The phosphorus compound is one or more of phosphoric acid, sodium phosphate, ammonium phosphate, metaphosphoric acid, sodium metaphosphate, ammonium metaphosphate, pyrophosphoric acid, sodium pyrophosphate, ammonium pyrophosphate, and P₂O₅.

Furthermore, each of Ti, Cd, Pb, Ni, Co, Cu, and Mo in the vanadium-chromium electrolyte has a content less than 2 mg/L.

Furthermore, each of Ti, Cd, Pb, Ni, Co, Cu, and Mo in the vanadium-chromium electrolyte has a content less than 0.1 mg/L.

Furthermore, the free acid is one of hydrochloric acid, sulfuric acid, phosphoric acid, and methanesulfonic acid; or is a mixture of more of hydrochloric acid, sulfuric acid, phosphoric acid, and methanesulfonic acid. The free acid is preferably selected from one or a mixture of more of hydrochloric acid, phosphoric acid, and methanesulfonic acid.

Furthermore, free hydrogen ions in the vanadium-chromium electrolyte have a concentration of 0.1 to 5 mol/L, preferably 0.5 to 4 mol/L, and more preferably 1 to 3 mol/L.

In a second aspect, a method for preparing a vanadium-chromium electrolyte is provided and includes the following steps:
in step 1, dissolving a vanadium compound with a free acid, and obtaining a mixed solution of the free acid and vanadium ions through filtering;
in step 2, electrolytically reducing vanadium to an average valence state of 3.5 to 4 valence;
in step 3, adding a chromium compound, dissolving through stirring, and implementing a filtering; and
in step 4, adding pure water and an auxiliary reagent to adjust concentration, and preparing the vanadium-chromium electrolyte.

Furthermore, the auxiliary agent includes, but is not limited to, a phosphorus compound.

Furthermore, the electrolytic reduction in step 2 includes: adopting a battery structure, in which an anode is a tetravalent vanadium solution and a cathode is a mixed solution, after charging, a valence state of vanadium ions in the anode increases to 5, and a valence state of vanadium ions in the mixed solution of the cathode decreases to 3.5 to 4.

In a third aspect, a use of the vanadium-chromium electrolyte in the field of redox flow battery is provided.

Furthermore, the vanadium-chromium electrolyte is used in a positive electrolyte and/or a negative electrolyte of the redox flow battery.

Furthermore, when the vanadium-chromium electrolyte is used in the positive electrolyte and the negative electrolyte of the redox flow battery, there may be differences in concentrations of vanadium and chromium in the positive electrolyte and the negative electrolyte, but a total amount of substance of vanadium in the positive electrolyte is equal to a sum of an amount of substance of vanadium and an amount of substance of chromium in the negative electrolyte.

In a fourth aspect, a vanadium-chromium redox flow battery is provided and includes a positive electrode, a negative electrode, and an ion membrane, and a positive electrolyte and/or a negative electrolyte of the vanadium-chromium redox flow battery adopts the above-mentioned vanadium-chromium electrolyte.

Furthermore, the ion membrane is a proton exchange membrane, which allows hydrogen ions to pass freely on both sides of the membrane.

Furthermore, the vanadium-chromium redox flow battery has an operating temperature of 0 to 50° C., preferably 10 to 45° C.

Furthermore, the vanadium-chromium redox flow battery has an energy density of 30 to 50 Wh/L, preferably 35 to 50 Wh/L, and more preferably 40 to 50 Wh/L.

Furthermore, the vanadium-chromium redox flow battery operates at room temperature, and a PP material or a PE material can be used as an electrode plate frame without a fluorine material. Based on the principle of the present disclosure, there is no need to use precious metals or carbon felts deposited with lead and bismuth as electrodes, reducing the cost and preventing hydrogen evolution reaction.

The working principle of the vanadium-chromium redox flow battery provided in the present disclosure is as follows:

the positive electrode utilizes the potential of VO₂⁺/VO₂⁺ and the negative electrode utilizes the potentials of V³⁺/V₂⁺ and Cr³⁺/Cr₂⁺ to constitute an electrochemical couple.

Although the standard potentials of V³⁺/V₂⁺ and Cr³⁺/Cr₂⁺ are lower than the standard potential of hydrogen, due to the reaction kinetics, both V³⁺/V₂⁺ and Cr³⁺/Cr₂⁺ can exist stably in an aqueous solution under the premise of controlling the concentration of hydrogen elements precipitated in the solution, so as to realize the charging and discharging of the battery.

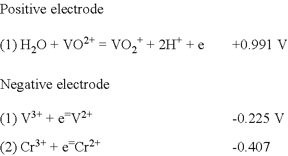

The discharging process is opposite.

### Beneficial Effects

The present disclosure provides a vanadium-chromium electrolyte, a method for preparing the same, and a redox flow battery containing the vanadium-chromium electrolyte, which have beneficial effects as follows.

(1) Since the potential of Cr(III)/Cr(II) is lower than the potential of V(III)/V(II), a voltage window of the battery is widened, and an average voltage of the battery increases from an average discharging voltage of vanadium battery, +1.25 V, to nearly +1.4 V. When the same amount of electricity is charged, the energy density of the battery increases by about 12%. Compared with the vanadium redox flow battery, the redox flow battery of the present disclosure improves the energy density of the solution, and can be increased from less than 30 Wh/L of the vanadium redox flow battery to more than 40 Wh/L.

(2) The charge-discharge SOC of the electrolyte of the present disclosure is significantly higher than that of the electrolyte of the vanadium redox flow battery. When the charge SOC is high, the potential of chromium in the negative electrode solution is low, and even if all vanadium is reduced, the occurrence of hydrogen evolution reaction can still be avoided. At the positive electrode, all vanadium can be oxidized to pentavalent vanadium due to the presence of chromium. Since the standard electrode potential of Cr⁶⁺/Cr³⁺ is 1.23 V, which is lower than the potential of precipitated chlorine and the potential of precipitated oxygen, when vanadium is completely oxidized to pentavalent vanadium, it can still ensure that the carbon electrode is not damaged and prevent the generation of chlorine gas. Therefore, the utilization rate of vanadium can be improved from 80% of hydrochloric acid system to 100%, which can significantly reduce the cost of the vanadium redox flow battery. Under the same energy density, using chromium instead of part of vanadium can also significantly reduce the cost of the battery.

(3) Compared with the iron-chromium redox flow battery, the potential of the positive electrode of the redox flow battery provided in the present disclosure is increased from +0.77 V to +0.99 V, and the recovery of the positive electrode can be realized by using a common reducing agent, so as to realize the long-term stable operation of the battery. Under the action of vanadium, the activity of chromium is released, and more than 80% of energy efficiency and more than 95% of Coulomb efficiency can be obtained only at room temperature.

(4) The electrochemical reaction activity of chromium can be significantly improved by adding chromium to the vanadium solution and assembling into a battery, avoiding the charging and discharging processes at high temperature (50 to 65° C.), reducing the system's requirements for the battery stack, and reducing side reaction of hydrogen evolution. When the charging and discharging reaction was carried out at 25° C., the battery efficiency of CE 96% and EE 85% can still be obtained. Moreover, replacing vanadium with chromium can significantly reduce the cost of the battery, increase the OCV to 1.6 V, and increase the energy density of the battery to more than 40 Wh/L.

### BRIEF DESCRIPTION OF THE DRAWINGS

FIG. 1 is changing curves of charge-discharge cycles and capacities of a vanadium redox flow battery;

FIG. 2 is changing curves of charge-discharge cycles and capacities of a vanadium-chromium battery;

FIG. 3 is curves of the charge-discharge cycles and efficiencies of the vanadium redox flow battery;

FIG. 4 is curves of the charge-discharge cycles and efficiencies of the vanadium-chromium redox flow battery;

FIG. 5 is curves of the charge-discharge cycles and voltages of the vanadium-chromium redox flow battery; and

FIG. 6 is a structure of the vanadium-chromium redox flow battery.

### DETAILED DESCRIPTION

The following will provide a clear and complete description of the technical solutions in the embodiments of the present disclosure, in conjunction with the drawings. Apparently, the described embodiments are only a part of the embodiments of the present disclosure, not all of them. Based on the embodiments of the present disclosure, all other embodiments obtained by those skilled in the art without creative labor are within the scope of protection of the present disclosure.

The present disclosure provides many different embodiments or examples for implementing different structures of the present disclosure. In order to simplify the present disclosure, the components and arrangements of specific examples are described in the present disclosure. Of course, they are merely examples and are not intended to limit the present disclosure. Furthermore, the present disclosure may repeat reference numerals and/or reference letters in different examples, such repetition is for the purpose of simplicity and clarity, without itself indicating a relationship between the various embodiments and/or arrangements discussed. In addition, the present disclosure provides examples of various specific processes and materials, but those of ordinary skill in the art may be aware of the application of other processes and/or the use of other materials.

### Example 1

This example provides a vanadium-chromium redox flow battery with high energy density, and a vanadium-chromium electrolyte used in the vanadium-chromium redox flow battery includes a negative electrolyte and a positive electrolyte.

The negative electrolyte contains 1.95 mol/L of V, 0.7 mol/L of Cr³⁺, 9.8 mol/L of Cl⁻, and 0.05 mol/L of phosphoric acid.

The positive electrolyte contains 1.95 mol/L of V, 0.7 mol/L of Cr³⁺, 9.8 mol/L of Cl⁻, and 0.05 mol/L of phosphoric acid.

A method for preparing the electrolyte of this example is as follows.

In step 1, VO₂ is dissolved with a hydrochloric acid, and a mixed solution of a free acid and vanadium ions is obtained through filtering.

In step 2, vanadium is electrolytically reduced to an average valence state of 3.5 to 4 valence.

In step 3, chromium trichloride is added and dissolved through stirring, and a filtering is implemented.

In step 4, pure water is added to adjust concentration, and the electrolyte is prepared.

### Comparative Example 1

This comparative example provides a vanadium redox flow battery electrolyte, and components and contents of which are shown in Table 1.

TABLE 1
Components and contents of the electrolytes
of Comparative Example 1 and Example 1

| | Comparative Example 1 | |
|---|---|---|
| | Vanadium redox flow | Example 1 Vanadium- |
| Name | battery electrolyte | chromium electrolyte |
| V | 1.65M | 1.95M |
| Cl | 0M | 9.8M |
| Cr | 0M | 0.7M |
| SO₄²⁻ | 4M | 0M |

In order to test the performance of the electrolytes of Example 1 and Comparative Example, each of them was used in a redox flow battery, and the performance thereof was tested. The redox flow battery included a positive conductive plate, a positive electrolyte, a positive frame, a positive electrode, an ion exchange membrane, a negative electrode, a negative electrolyte, a negative frame, and a negative conductive plate, which were sequentially compressed to form a battery structure.

The positive frame constituted a cavity, the positive electrode was placed in the frame, the electrolyte was in contact with the electrode, and an electrochemical reaction occurred on the electrode.

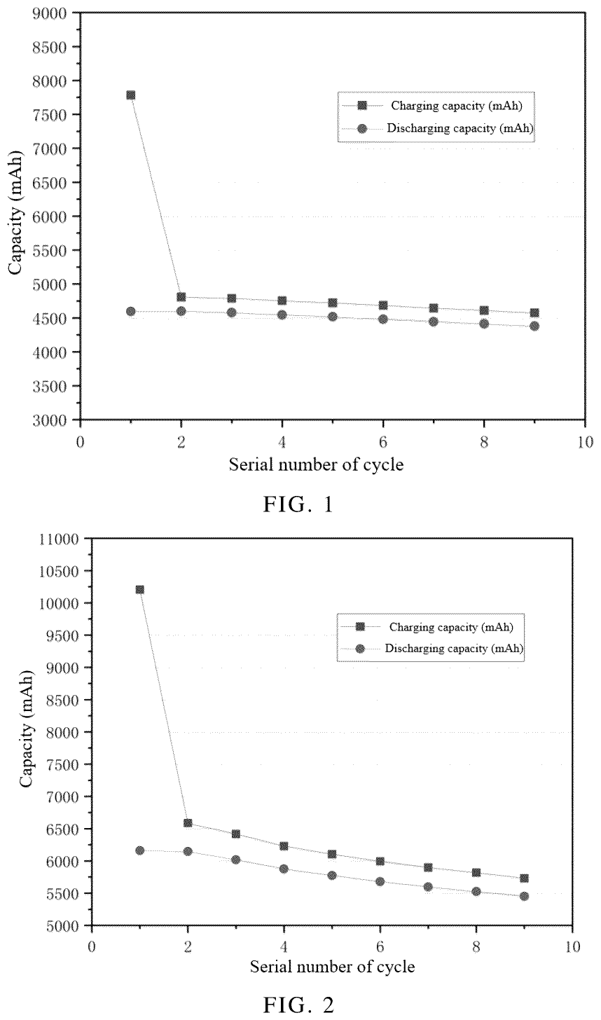

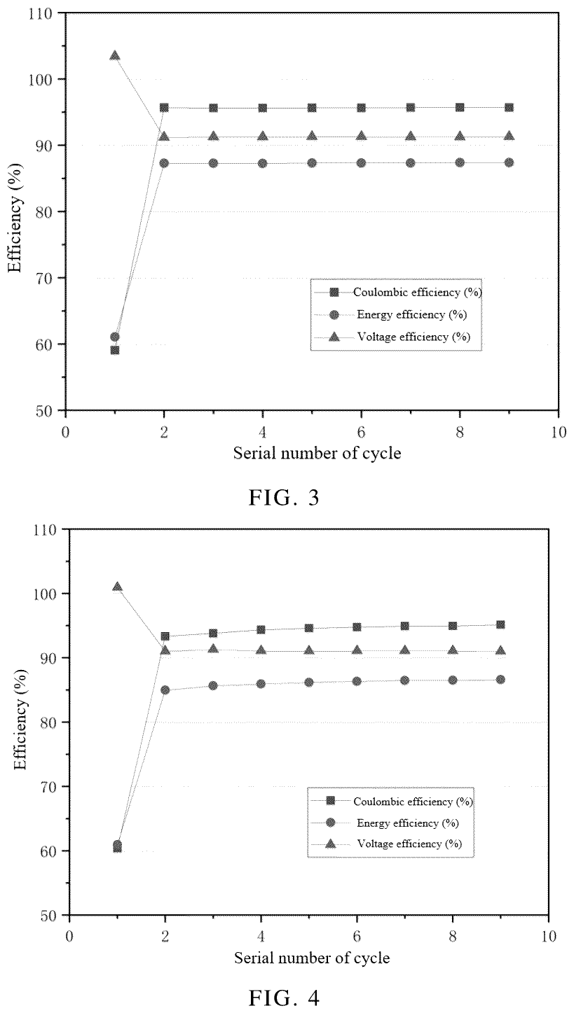

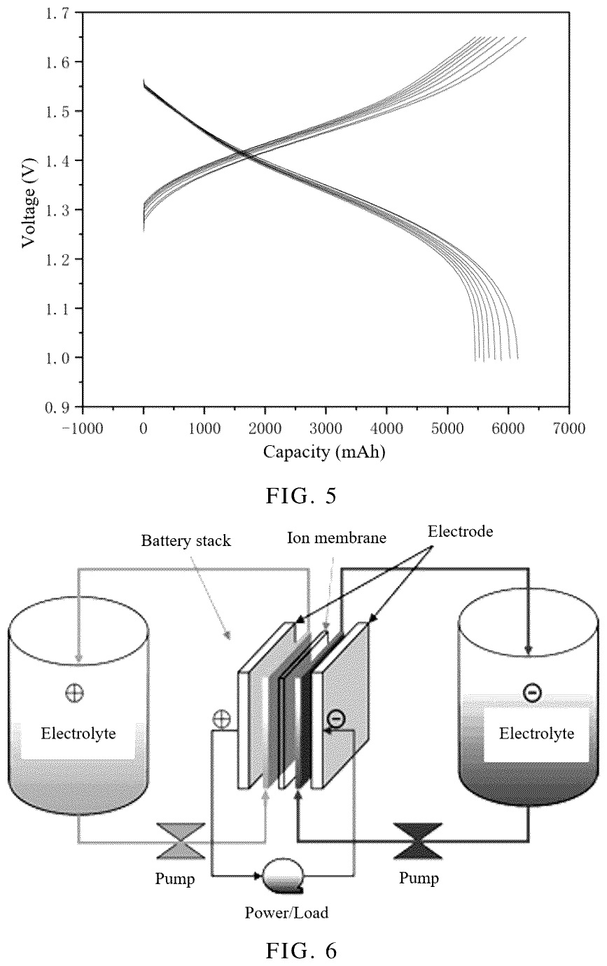

The negative electrolyte and the positive electrolyte of Example 1 were respectively placed on both sides of a dual redox flow battery shown in FIG. 6 at a volume ratio of 1:1.36, and pumped into a negative cavity and a positive cavity of the battery, respectively. A charge-discharge cycle was carried out at 30° C. Charging was carried out at constant current of 100 mA/cm² with a cut-off voltage of 1.65 V, and carried out to 50 mA/cm² at a constant voltage. Discharging was carried out at constant current of 100 mA/cm² with a cut-off voltage of 1 V. The charge-discharge cycle curves are shown in FIG. 2, FIG. 4, and FIG. 5. Similarly, the vanadium redox flow battery electrolytes (1.65M of V) of Comparative Example 1 were respectively placed on both sides of the dual redox flow battery at a volume ratio of 1:1, and pumped into the positive and negative cavities of the battery, respectively. The charge-discharge cycle was carried out at 30° C. Charging was carried out at constant current of 100 mA/cm² with a cut-off voltage of 1.55 V, and carried out to 50 mA/cm² at a constant voltage. Discharging was carried out at constant current of 100 mA/cm² with a cut-off voltage of 1 V. The cycle curves are shown in FIG. 1 and FIG. 3. The charge-discharge cycle experiment shows that the vanadium-chromium redox flow battery of Example 1 has an energy density of 43 Wh/L, and the vanadium redox flow battery of Comparative Example 1 has an energy density of 26 Wh/L.

Compared with the concentration of vanadium in the vanadium mixed acid system of Comparative Example 1, the amount of vanadium consumed per unit energy of the electrolyte of Example 1 was reduced from 5.775 KgV₂O₅/KWh to 4.13 KgV₂O₅/KWh, the amount of vanadium was reduced by 28.5%, increased by 4.34 Kg of CrCl₃.6H₂O/KWh, and the cost was reduced by 300 RMB/KWh.

### Example 2

This example provides a redox flow battery with high energy density, and a vanadium electrolyte used in the vanadium redox flow battery includes a negative electrolyte and a positive electrolyte.

The negative electrolyte contains 2.5 mol/L of V, 0.5 mol/L of Cr³⁺, 9.2 mol/L of Cl, 0.6 mol/L of SO₄²⁻.

The positive electrolyte contains 3 mol/L of V, 0.3 mol/L of Cr³⁺, 8.1 mol/L of Cl, 0.9 mol/L of SO₄²⁻.

Steps of methods for preparing and testing the negative electrolyte and the positive electrolyte are basically the same as those of Example 1, except that types and contents of active substances are adjusted. The negative electrolyte and the positive electrolyte were placed in the dual redox flow battery at a volume ratio of 1:1, pumped into the positive and negative cavities of the battery, respectively, and carried out a charge-discharge cycle at room temperature.

The negative electrolyte and the positive electrolyte were respectively placed in the dual redox flow battery at a volume ratio of 1:1, and pumped into the negative and positive cavities of the battery, respectively. The charge-discharge cycle was carried out at 30° C. Charging was carried out at constant current of 100 mA/cm² with a cut-off voltage of 1.65 V, and carried out to 50 mA/cm² at a constant voltage. Discharging was carried out at constant current of 100 mA/cm² with a cut-off voltage of 1 V. The charge-discharge cycle curves are shown in FIG. 1 and FIG. 3. Similarly, the vanadium redox flow battery electrolytes (1.65M of V) of Comparative Example 1 were respectively placed on both sides of the dual redox flow battery at a volume ratio of 1:1, and pumped into the positive and negative cavities of the battery, respectively. The charge-discharge cycle was carried out at 30° C. Charging was carried out at constant current of 100 mA/cm² with a cut-off voltage of 1.55 V, and carried out to 50 mA/cm² at a constant voltage. Discharging was carried out at constant current of 100 mA/cm² with a cut-off voltage of 1 V. The charge-discharge cycle experiment shows that the vanadium-chromium redox flow battery of this example has an energy density of 50 Wh/L.

### Example 3

On the basis of Example 2, 0.12 mol/L of H₃PO₄ was added to the positive and negative electrolytes, respectively.

The negative electrolyte contains 2.5 mol/L of V, 0.5 mol/L of Cr³⁺, 9.2 mol/L of Cl, 0.6 mol/L of SO₄²⁻, and 0.12 mol/L of H₃PO₄.

The positive electrolyte contains 3 mol/L of V, 0.3 mol/L of Cr³⁺, 8.1 mol/L of Cl, 0.9 mol/L of SO₄²⁻, and 0.12 mol/L of H₃PO₄.

Steps of methods for preparing and testing the negative electrolyte and the positive electrolyte are basically the same as those of Example 1, except that types and contents of active substances are adjusted. The negative electrolyte and the positive electrolyte were respectively placed in the dual redox flow battery at a volume ratio of 1:1, and pumped into the negative and positive cavities of the battery, respectively. A charge-discharge cycle was carried out at 30° C. Charging was carried out at constant current of 100 mA/cm² with a cut-off voltage of 1.65 V, and carried out to 50 mA/cm² at a constant voltage. Discharging was carried out at constant current of 100 mA/cm² with a cut-off voltage of 1 V. The charge-discharge cycle curves are shown in FIG. 1 and FIG. 3. Similarly, the vanadium redox flow battery electrolytes (1.65M of V) of Comparative Example 1 were respectively placed on both sides of the dual redox flow battery at a volume ratio of 1:1, and pumped into the positive and negative cavities of the battery, respectively. The charge-discharge cycle was carried out at 30° C. Charging was carried out at constant current of 100 mA/cm² with a cut-off voltage of 1.55 V, and carried out to 50 mA/cm² at a constant voltage. Discharging was carried out at constant current of 100 mA/cm² with a cut-off voltage of 1 V. The charge-discharge cycle experiment shows that the vanadium-chromium redox flow battery of this example has an energy density of 52 Wh/L.

The batteries of Examples 2 and 3 were charged to 95% SOC, and a ratio of an amount of substance of pentavalent vanadium to a total amount of substance of vanadium in the positive electrolyte satisfied: VO₂⁺/V_{Total}=95%. The positive electrolyte was sealed, placed in an environment of 30° C., 40° C., and 50° C., stored for 1 to 5 days, and observed the stability. It can be seen from the data in Table 2 that, after adding phosphorus, precipitation only appears on the fifth day at 50° C., indicating that the adding of the phosphorus compound can significantly improve the high-temperature stability of the positive electrolyte.

TABLE 2
Stability experiments

| | Example 2 Positive electrolyte | | | | | Example 3 Positive electrolyte | | | | |
|---|---|---|---|---|---|---|---|---|---|---|
| | (Not adding phosphorus) | | | | | (Adding phosphorus) | | | | |
| | 1 | 2 | 3 | 4 | 5 | 1 | 2 | 3 | 4 | 5 |
| Temperature | day | days | days | days | days | day | days | days | days | days |
| 30° C. | ✓ | ✓ | ✓ | ✓ | ✓ | ✓ | ✓ | ✓ | ✓ | ✓ |
| 40° C. | ✓ | ✓ | ✓ | x | x | ✓ | ✓ | ✓ | ✓ | ✓ |
| 50° C. | x | x | x | x | x | ✓ | ✓ | ✓ | ✓ | x |

Note:
✓ represents that the solution was stable and unchanged, and x represents that precipitation occurred.

### Example 4

This example provides a redox flow battery with high energy density, and a vanadium electrolyte used in the vanadium redox flow battery includes a negative electrolyte and a positive electrolyte.

The negative electrolyte contains 1 mol/L of V, 1.5 mol/L of Cr³⁺, and 10 mol/L of Cl⁻.

The positive electrolyte contains 1.5 mol/L of V, 0.3 mol/L of Cr³⁺, and 6.8 mol/L of Cl⁻.

Steps of methods for preparing and testing the negative electrolyte and the positive electrolyte are basically the same as those of Example 1, except that types and contents of active substances are adjusted. The negative electrolyte and the positive electrolyte were respectively placed in the dual redox flow battery at a volume ratio of 1:1.67, and pumped into the negative and positive cavities of the battery, respectively. A charge-discharge cycle was carried out at 30° C. Charging was carried out at constant current of 100 mA/cm² with a cut-off voltage of 1.65 V, and carried out to 50 mA/cm² at a constant voltage. Discharging was carried out at constant current of 100 mA/cm² with a cut-off voltage of 1 V. The charge-discharge cycle experiment shows that the vanadium-chromium redox flow battery of this example has an energy density of 54 Wh/L and an energy efficiency of 81%.

Although the energy density of the battery in this example does not reach 40 Wh/L, the amount of vanadium consumed per unit energy is 62% of the standard electrolyte of 1.65 M of the vanadium redox flow battery. Moreover, reducing the concentration of vanadium is beneficial to improving the high-temperature stability of the positive electrolyte. The positive electrolyte provided in this example can operate stably at a high temperature above 50° C.

### Example 5

This example provides a redox flow battery, and a vanadium-chromium electrolyte used in the redox flow battery includes a negative electrolyte and a positive electrolyte.

The negative electrolyte contains 0.8 mol/L of V, 0.9 mol/L of Cr³⁺, and 8 mol/L of Cl⁻.

The positive electrolyte contains 1.5 mol/L of V, 0.2 mol/L of Cr³⁺, and 6.8 mol/L of Cl⁻.

Steps of methods for preparing and testing the negative electrolyte and the positive electrolyte are basically the same as those of Example 1, except that types and contents of active substances are adjusted. The negative electrolyte and the positive electrolyte were respectively placed in the battery at a volume ratio of 1:1.13, and pumped into the negative and positive cavities of the battery, respectively. A charge-discharge cycle was carried out at 30° C. Charging was carried out at constant current of 100 mA/cm² with a cut-off voltage of 1.65 V, and carried out to 50 mA/cm² at a constant voltage. Discharging was carried out at constant current of 100 mA/cm² with a cut-off voltage of 1 V. The energy efficiency of the charge-discharge cycle is 86%.

### Example 6

This example provides a redox flow battery, and a vanadium-chromium electrolyte used in the redox flow battery includes a negative electrolyte and a positive electrolyte.

The negative electrolyte contains 0.2 mol/L of V, 1.5 mol/L of Cr³⁺, and 8 mol/L of Cl⁻.

The positive electrolyte contains 1.5 mol/L of V, 0.2 mol/L of Cr³⁺, and 6.8 mol/L of Cl⁻.

Steps of methods for preparing and testing the negative electrolyte and the positive electrolyte are basically the same as those of Example 1, except that types and contents of active substances are adjusted. The negative electrolyte and the positive electrolyte were respectively placed in the battery at a volume ratio of 1:1.13, and pumped into the negative and positive cavities of the battery, respectively. A charge-discharge cycle was carried out at 30° C. Charging was carried out at constant current of 100 mA/cm² with a cut-off voltage of 1.65 V, and carried out to 50 mA/cm² at a constant voltage. Discharging was carried out at constant current of 100 mA/cm² with a cut-off voltage of 1 V. The energy efficiency of the charge-discharge cycle is 70%.

Compared with Example 5, a difference between Example 6 and Example 5 is only a ratio of an amount of substance of vanadium and an amount of substance of chromium in the negative electrode. A molar ratio of vanadium and chromium in the negative electrode of Example 6 is 0.13, while a molar ratio of vanadium and chromium in the negative electrode of Example 5 is 0.89, and the others are the same. The test results show that the battery efficiency of chromium is low in a low ratio range of vanadium to chromium, similar to that of the iron-chromium battery, because when the vanadium concentration is low, the activity of chromium is difficult to be improved through the catalysis of vanadium.

Finally, it should be noted that: the above examples are merely used to illustrate the technical solutions of the present disclosure, and are not intended to limit the technical solutions thereof. Although the present disclosure has been described in detail with reference to the above-mentioned examples, those of ordinary skill in the art will understand that: the technical solutions described in the above-described examples may still be modified, or some or all of the technical features may be equivalently replaced. However, these modifications or substitutions do not cause the essence of the corresponding technical solutions to deviate from the scope of the technical solutions of each example of the present disclosure.

1. A vanadium-chromium electrolyte comprising active substances and a free acid, wherein the free acid acts as a proton conductive agent after ionization, and the active substances contain at least vanadium ions and chromium ions.

2. The vanadium-chromium electrolyte according to claim 1, wherein the active substances are a vanadium compound and a chromium compound.

3. The vanadium-chromium electrolyte according to claim 2, wherein the vanadium compound is one or more of VO₂, V₂O₃, V₆O₁₃, V₂O₅, CrVO₄, VOSO₄, V₂(SO₄)₃, VCl₂, VOCl₂, and VCl₃.

4. The vanadium-chromium electrolyte according to claim 2, wherein the chromium compound is one or more of chromium trichloride, chromium dichloride, chromium sulfate, chromium vanadate, and Cr₂O₃.

5. The vanadium-chromium electrolyte according to claim 1, wherein the vanadium ions have a concentration of 0.1 to 5 mol/L.

6. The vanadium-chromium electrolyte according to claim 5, wherein the vanadium ions have a concentration of 0.5 to 3 mol/L.

7. The vanadium-chromium electrolyte according to claim 1, wherein the chromium ions have a concentration of 0.1 to 2 mol/L.

8. The vanadium-chromium electrolyte according to claim 7, wherein the chromium ions have a concentration of 0.4 to 2 mol/L.

9. The vanadium-chromium electrolyte according to claim 1, wherein a phosphorus compound in the vanadium-chromium electrolyte has a concentration of 0 to 1 mol/L.

10. The vanadium-chromium electrolyte according to claim 9, wherein the phosphorus compound in the vanadium-chromium electrolyte has a concentration of 0.05 to 0.6 mol/L.

11. The vanadium-chromium electrolyte according to claim 9, wherein the phosphorus compound is one or more of phosphoric acid, sodium phosphate, ammonium phosphate, metaphosphoric acid, sodium metaphosphate, ammonium metaphosphate, pyrophosphoric acid, sodium pyrophosphate, ammonium pyrophosphate, and P₂O₅.

12. The vanadium-chromium electrolyte according to claim 1, wherein each of Ti, Cd, Pb, Ni, Co, Cu, and Mo in the vanadium-chromium electrolyte has a content less than 2 mg/L.

13. The vanadium-chromium electrolyte according to claim 1, wherein the free acid is one of hydrochloric acid, sulfuric acid, phosphoric acid, and methanesulfonic acid; or is a mixture of more of hydrochloric acid, sulfuric acid, phosphoric acid, and methanesulfonic acid.

14. The vanadium-chromium electrolyte according to claim 1, wherein free hydrogen ions in the vanadium-chromium electrolyte have a concentration of 0.1 to 5 mol/L.

15. A method for preparing a vanadium-chromium electrolyte, comprising the following steps:
in step 1, dissolving a vanadium compound with a free acid, and obtaining a mixed solution of the free acid and vanadium ions through filtering;
in step 2, electrolytically reducing vanadium to an average valence state of 3.5 to 4 valence;
in step 3, adding a chromium compound, dissolving through stirring, and implementing a filtering; and
in step 4, adding pure water and an auxiliary reagent to adjust concentration, and preparing the vanadium-chromium electrolyte.

16. The method for preparing the vanadium-chromium electrolyte according to claim 15, wherein the electrolytic reduction in the step 2 comprises: adopting a battery structure, in which an anode is a tetravalent vanadium solution and a cathode is a mixed solution, after charging, a valence state of vanadium ions in the anode increases to 5, and a valence state of vanadium ions in the mixed solution of the cathode decreases to 3.5 to 4.

17. A use of the vanadium-chromium electrolyte according to claim 1 in the field of redox flow battery.

18. A vanadium-chromium redox flow battery comprising a positive electrode, a negative electrode, and an ion membrane, wherein a positive electrolyte and/or a negative electrolyte of the vanadium-chromium redox flow battery adopts the vanadium-chromium electrolyte according to claim 1.

19. The vanadium-chromium redox flow battery according to claim 18, wherein the vanadium-chromium redox flow battery has an operating temperature of 0 to 50° C.

20. The vanadium-chromium redox flow battery according to claim 18, wherein the vanadium-chromium redox flow battery has an energy density of 30 to 50 Wh/L.
